(19) United States
(12) Patent Application Publication
(10) Pub. No.: US 2007/0197113 A1
(43) Pub. Date: Aug. 23, 2007

(54) Cleaner for display of mobile phone

(76) Inventor: Takayoshi Tomo, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 11/356,179

(22) Filed: Feb. 17, 2006

(51) Int. Cl. B32B 27/04; B32B 27/12; B32B 5/26

(52) U.S. Cl. 442/149; 442/151; 442/286; 442/263

(57) ABSTRACT

A cleaner for display of mobile phone with which a display of a mobile phone can be easily cleaned. A reinforcing resin film and a pressure-sensitive adhesive layer for detachable attachment to a mobile phone main body are serially layered on a reverse face of a fiber cloth. The resin film is composed of polyethylene terephthalate. Thickness of the resin film is set to be 45 μm to 110 μm.

### BACKGROUND OF THE INVENTION

1. Field of the Invention

This invention relates to a cleaner for display of mobile phone.

2. Description of the Related Art

Conventionally, a cleaner which has cloth for liquid crystal display of mobile (portable) phone has been used for cleaning of display (liquid crystal display) of mobile phone (refer to Japanese Utility Model No. 3093247 for example).

However, the conventional portable cleaner for liquid crystal display, used while attached to a strap of a mobile phone, has a disadvantage that motion of hand is restricted (by the strap) and cleaning is hindered thereby.

It is therefore an object of the present invention to provide a cleaner for display of mobile phone which can easily clean the display of mobile phone and be produced with low cost.

### BRIEF DESCRIPTION OF THE DRAWINGS

The present invention will be described with reference to the accompanying drawings in which:

FIG. 1 is an explanatory view showing a used state of the present invention;

FIG. 2 is an explanatory view showing a used state of the present invention; and

FIG. 3 is a cross-sectional front view showing an embodiment of the present invention.

### PREFERRED EMBODIMENTS OF THE INVENTION

Preferred embodiments of the present invention will now be described with reference to the accompanying drawings.

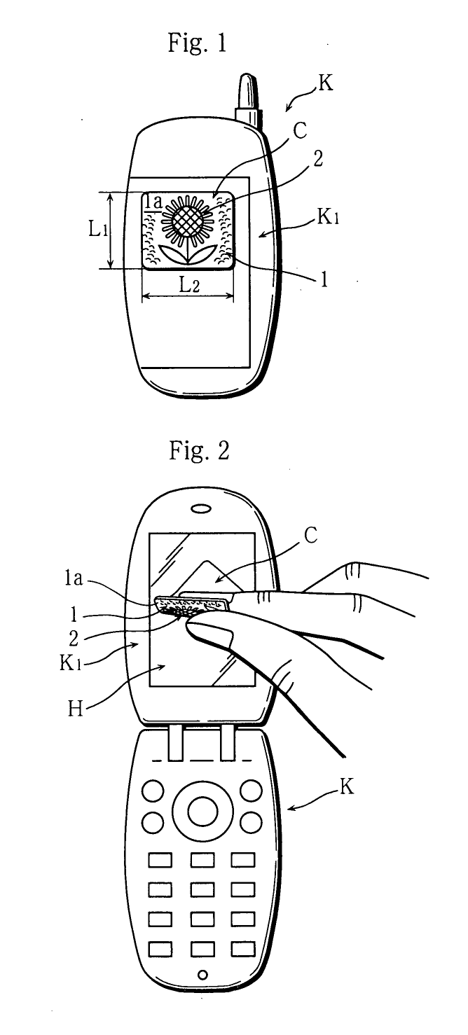

FIG. 1 shows a state in which an embodiment of the present invention is detachably attached to a mobile phone main body K₁. To use this cleaner C for display of mobile phone, the cleaner C is removed from the mobile phone main body K₁, and a fiber cloth 1 is slid on a display H to wipe dust and oil stains off the display H. The entire configuration of the cleaner C is a rectangular sheet of which longitudinal dimension L₁ is set to be 25 mm≦L₁≦35 mm and lateral dimension L₂ is set to be 25 mm≦L₂≦35 mm. When the longitudinal dimension L₁ and the lateral dimension L₂ are smaller than the dimensions above, the cleaner C is difficult to be held by hand to use. And, when the longitudinal dimension L₁ and the lateral dimension L₂ are longer than the dimensions above, the cleaner C may partially outsize the mobile phone main body K₁ when attached to the mobile phone main body K₁. An advertisement indicating portion 2 of offset printing is on an obverse face 1a of the fiber cloth 1. The advertisement indicating portion 2 is, for example, composed of letters, illustrations, design patterns, etc., and preferably indicating trademarks, corporate names, brand names, etc.

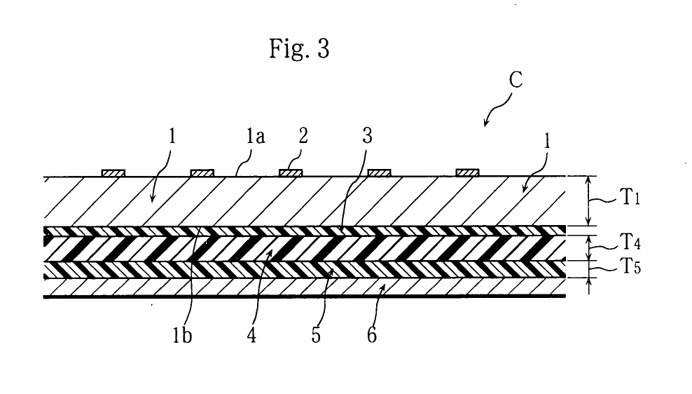

As shown in FIG. 3, the cleaner C is composed of an adhesive layer 3 of acrylic adhesive, a reinforcing resin film 4, a pressure-sensitive adhesive layer 5 for detachable attachment to the mobile phone main body K₁ (refer to FIGS. 1 and 2), and a released paper 6 serially layered on a reverse face 1b of the fiber cloth 1 (the released paper 6 is peeled off before the attachment to the mobile phone main body K₁ as shown in FIG. 1).

Diameter d of fiber of the fiber cloth 1 is set to be 1 μm≦4 μm. In case of d<1 μm, the production of the cleaner becomes laborsome and causes high cost. And, in case of 4 μm<d, efficiency of wiping off the dust and oil stains is reduced. Thickness T₁ of the fiber cloth 1 is set to be 250 μm≦T₁≦350 μm. In case of T₁<250 μm, the production of the cleaner becomes laborsome and causes high cost. And, in case of 350 μm<T₁, wiping ability is not enhanced further, and efficiency is reduced. Cloths for cleaning eyeglasses produced by Kanebo Ltd. can be used as the fiber cloth 1.

The resin film 4 is composed, for example, of polyethylene terephthalate, Polyester, Polyvinyl, etc. The fiber cloth 1 can be made strong (reinforced against folding) by the resin film 4 even if the fiber cloth is soft and weak against folding. Thickness T₄ of the resin film 4 is set to be 45 μm≦T₄≦110 μm. When the thickness T₄ is within the range above, the cleaner C has appropriate rigidity when bent, and the dust and oil stains on the display H of the mobile phone K (refer to FIGS. 1 and 2) can be easily wiped off for the rigidity despite the small entire configuration of the cleaner. In case of T₄<45 μm, the rigidity of the cleaner C when bent is low, and this makes it difficult to wipe the dust and oil stains off the display H of the mobile phone K. And, in case of 110 μm<T₄, relatively strong force is required to bend the cleaner C and this reduces utility of the cleaner. The thickness T₄ of the resin film 4 is preferably set to be 60 μm≦T₄≦100 μm.

The pressure-sensitive adhesive layer 5 is composed, for example, of urethane system adhesive. Thickness T₅ of the pressure-sensitive adhesive layer 5 is set to be 30 μm≦T₅≦70 μm. When the thickness T₅ is within the range above, appropriate adherence can be efficiently obtained. In case of T₅<30 μm, the adherence may be low. And, in case of 110 μm<T₅, the adherence is not enhanced further, and efficiency is reduced. The pressure-sensitive adhesive layer 5 is preferably ripened, for example, in a room kept at 80° C. for 10 days.

The released paper 6 is composed, for example, of silicone paper.

The present invention, modifiable in design, for example, may have a circular entire configuration. And, instead of the advertisement indicating portion 2, unique designs of art or names may be indicated.

As described above, with the present invention in which the reinforcing resin film 4 and the pressure-sensitive adhesive layer 5 for detachable attachment to the mobile phone main body K₁ are serially layered on the reverse face 1b of the fiber cloth 1, a user can freely move the hand without restriction of hand movement by the length of the strap, and the display H of the mobile phone K is easily wiped with strength by the rigidity of the reinforcing resin film 4. Especially, appropriate rigidity is given even if the entire thickness is small. Even a small face can be well-polished for the rigidity. And, the cleaner can be compact to carry because the strap is unnecessary, namely, not to be an obstacle. The cleaner can be made with low cost for the simple construction. Further, when the fiber cloth 1 becomes dirty for use, wiping ability can be recovered by washing the fiber cloth 1. When the adherence of the pressure-sensitive adhesive layer 5 becomes weak, the adherence can be recovered by wiping the surface with a wet cloth or washing the layer with neutral detergent to remove the dust. And, dust and oil stains on glass, plastic, or metal can be easily wiped off.

And, appropriate rigidity can be obtained, and the display H of the mobile phone K can be easily wiped for easy handling because the resin film 4 is composed of polyethylene terephthalate, and thickness T₄ of the resin film 4 is set to be 45 μm≦T₄110 μm.

The cleaner is easy to handle and attached to the mobile Phone main body K₁ as not to oversize the mobile phone main body K₁ because entire configuration of the cleaner is of rectangle sheet, the longitudinal dimension L₁ of the rectangle is set to be 25 mm≦L₁≦35 mm, and the lateral dimension L₂ of the rectangle is set to be 25 mm≦L₂≦35 mm.

The cleaner is easily made and having high efficiency of wiping off the dust and oil stains because the diameter d of fiber of the fiber cloth 1 is set to be 1 μm≦d≦4 μm. And, advertisement is effectively directed to the user and people around the user because the advertisement indicating portion 2 of offset printing is on the obverse face 1a of the fiber cloth 1. And, the obverse face 1a of the fiber cloth 1 has no irregularity for good feeling in use.

While preferred embodiments of the present invention have been described in this specification, it is to be understood that the invention is illustrative and not restrictive, because various changes are possible within the spirit and indispensable features.

1. A cleaner for display of mobile phone comprising a construction in which a reinforcing resin film and a pressure-sensitive adhesive layer for detachable attachment to a mobile phone main body are serially layered on a reverse face of a fiber cloth.

2. The cleaner for display of mobile phone as set forth in claim 1, wherein the resin film is composed of polyethylene terephthalate, and thickness of the resin film is set to be 45 μm to 110 μm.

3. The cleaner for display of mobile phone as set forth in claim 1, wherein entire configuration of the cleaner is of rectangle sheet, a longitudinal dimension of the rectangle is set to be 25 mm to 35 mm, and a lateral dimension of the rectangle is set to be 25 mm to 35 mm.

4. The cleaner for display of mobile phone as set forth in claim 1, wherein a diameter of fiber of the fiber cloth is set to be 1 μm to 4 μm, and an advertisement indicating portion of offset printing is on an obverse face of the fiber cloth.

5. The cleaner for display of mobile phone as set forth in claim 3, wherein a diameter of fiber of the fiber cloth is set to be 1 μm to 4 μm, and an advertisement indicating portion of offset printing is on an obverse face of the fiber cloth.

6. The cleaner for display of mobile phone as set forth in claim 2, wherein entire configuration of the cleaner is of rectangle sheet, a longitudinal dimension of the rectangle is set to be 25 mm to 35 mm, and a lateral dimension of the rectangle is set to be 25 mm to 35 mm.

7. The cleaner for display of mobile phone as set forth in claim 2, wherein a diameter of fiber of the fiber cloth is set to be 1 μm to 4 μm, and an advertisement indicating portion of offset printing is on an obverse face of the fiber cloth.

8. The cleaner for display of mobile phone as set forth in claim 6, wherein a diameter of fiber of the fiber cloth is set to be 1 μm to 4 μm, and an advertisement indicating portion of offset printing is on an obverse face of the fiber cloth.
